(19) United States
(12) Patent Application Publication
(10) Pub. No.: US 2005/0078434 A1
(43) Pub. Date: Apr. 14, 2005

(54) Substrate for a semiconductor device

(76) Inventor: Wen Seng Ho, Singapore (SG)

Correspondence Address: SLATER & MATSIL LLP, 17950 PRESTON ROAD, SUITE 1000, DALLAS, TX, 75252, US

(21) Appl. No.: 10/927,786

(22) Filed: Aug. 27, 2004

Related U.S. Application Data
(63) Continuation of application No. PCT/SG02/00032, filed on Feb. 28, 2002.

(51) Int. Cl. H01G 4/38

(52) U.S. Cl. 361/329

(57) ABSTRACT

A substrate (1) is for mounting a semiconductor device (5) thereon. The substrate has a first region (2) adapted to have a semiconductor device (5) attached thereto, a second region having a number of electrical contacts (3), and a third region located between the first region (2) and the second region. The third region includes a stress relief means (4) such as an aperture.

This application is a continuation of co-pending International Application No. PCT/SG02/00032, filed Feb. 28, 2002, which designated the United States and was published in English, which application is incorporated herein by reference.

### TECHNICAL FIELD

The invention relates to a substrate for a semiconductor device, and especially, a laminated substrate.

### BACKGROUND

During packaging of semiconductor devices on laminated substrates, it is common for the packaged device to be subjected to a thermal cycling process after a molding compound has been molded around the substrate and the die that is attached to the substrate. Unfortunately, such thermal cycling induces stress in the substrate due to the difference in the thermal expansion coefficients between the substrate and the die. This stress can lead to cracking of the substrate, which is a problem as it can result in breaking of the electrical traces on the substrate, and so result in failure of the electrical circuit on the substrate.

There have been various proposals to overcome this problem, such as using a die attach material and/or mold compound which permits relative expansion or contraction between the die and the substrate. However, the difficulty with this solution is in finding a suitable material for the particular package design and processing during packaging.

Another solution is to provide a surface treatment on the substrate to improve the interfacial adhesion to contain the stress. However, this solution may not prevent delamination.

A third solution is to reduce stress by reducing the number of thermal cycles and/or the temperature range of the thermal cycling. However, this can still lead to some cracking problems and does not sufficiently minimize the problem.

### SUMMARY OF THE INVENTION

In accordance with a first aspect of the present invention, there is provided a substrate for mounting a semiconductor device thereon, the substrate comprising a first region adapted to have a semiconductor device attached thereto, a second region having a number of electrical contacts, and a third region located between the first region and the second region, the third region comprising a stress relief means.

In accordance with a second aspect of the present invention, there is provided a packaged semiconductor device comprising a substrate, the substrate comprising a first region having a semiconductor device mounted thereon, a second region having a number of electrical contacts and a third region; electrical interconnects extending between electrical contacts on the semiconductor device and the electrical contacts on the second region; an electrical insulating material encapsulating the semiconductor device, the electrical interconnects, the electrical contacts in the second region and the third region; and the third region comprising stress relief means.

Preferably, the stress relief means comprises an aperture in the substrate and typically, may comprise a slot or a number of slots.

In one example, the slot may be an elongated slot. The slot may be linear or non-linear.

In another example, the aperture may comprise a hole, and preferably a number holes.

Preferably, the substrate is a substrate of a type known as a laminated substrate, which includes an insulating core material.

### BRIEF DESCRIPTION OF THE DRAWINGS

An example of a substrate for a semiconductor device in accordance with the invention will now be described with reference to the accompanying drawings, in which:

FIG. 1 is a plan view of a substrate with a first aperture design;

FIG. 2 is a cross-sectional view of the substrate with a semiconductor device attached to the substrate; and

FIGS. 3a to 3d show examples of alternative aperture designs.

### DETAILED DESCRIPTION OF ILLUSTRATIVE EMBODIMENTS

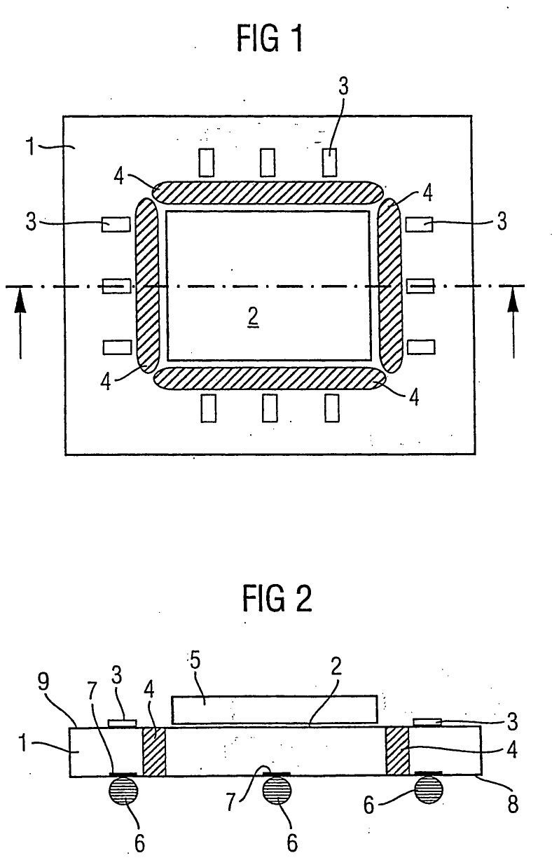

FIG. 1 shows a substrate 1 having a die attach portion 2, electrical contacts in the form of bond fingers 3 and slots 4 separating the bond fingers 3 from the die attach portion 2. The substrate 1 is of the type commonly known as a laminated substrate and typically has a glass fiber insulating core.

A cross-sectional view of the substrate is shown in FIG. 2 in which a die 5 is also shown attached to the die attach portion 2. In addition, FIG. 2 also shows solder balls 6 which are formed on electrical contacts 7 formed on the underside 8 of the substrate 1. In addition, it can be seen from FIG. 2 that the slots 4 extend through the substrate 1 from the upperside 9 on which the die 5 is attached, to the underside 8.

After the die 5 is attached to the die attach portion 2, wire bonds are formed between contact pads (not shown) on the die 5 and the contacts 3. An electrically insulating material is then molded around the die 5, substrate 1 and wire bonds to protect the device.

After molding, the packaged device is subjected to thermal cycling. The thermal coefficient of expansion of the die and the thermal coefficient of expansion of the substrate are different and during the thermal cycling, the slots 4 act as a stress relief means to minimize stress between the die 5 and the die attach portion 2 of the substrate 1 being transferred to other regions of the substrate 1, such as the region of the substrate 1 in which the bond fingers 3 are located. In addition, the slots 4 help to reduce any cracking of the substrate 1 in the die attach portion 2 propagating to other regions of the substrate.

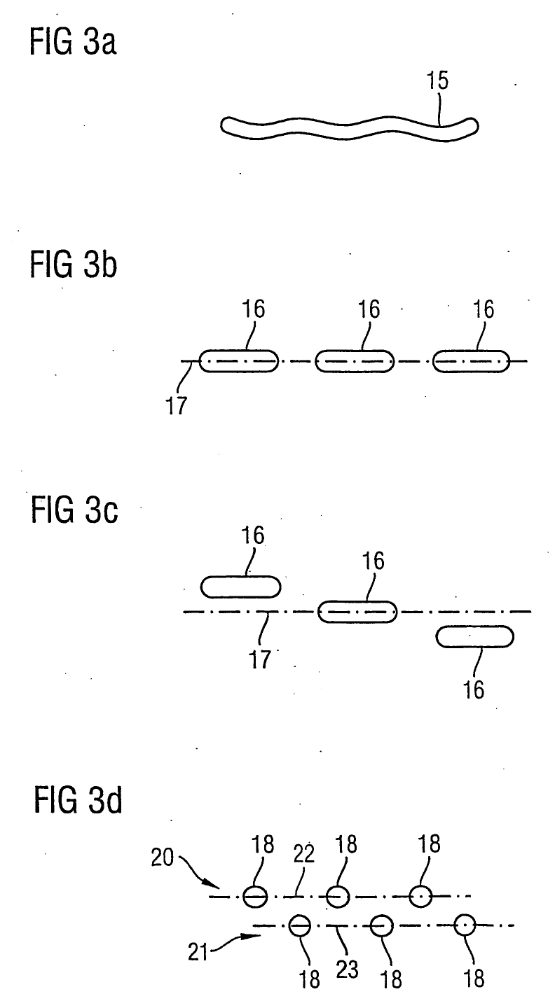

As an alternative to the slots 4, other configurations of apertures are possible, such as those shown in FIGS. 3a to 3d.

FIG. 3a shows a slot 15 that is non-linear. A slot 15 could be used to replace each of the slots 4 in the substrate 1.

FIG. 3b shows a series of three slots 16 arranged in line with each other on an axis 17. One set of three slots 16 could be used to replace each of the slots 4 in the substrate 1.

FIG. 3c shows another alternative that also uses three slots 16. However the two end slots 16 are displaced laterally from the central axis 17, on which the central slot 16 is located.

FIG. 3d shows a further example in which six circular apertures 18 are used to replace each of the slots 4 in the substrate 1. In this example, the circular apertures 18 are split into two sets 20, 21 of three apertures. The apertures 18 of one set 20 are aligned on an axis 22 and the aperture 18 of the other set 21 are aligned on an axis 23 displaced laterally from the axis 22. In addition, the apertures 18 in set 21 are offset from the apertures 18 in set 20.

An advantage of the invention is that by providing a stress relief means between the die attach portion 2 and the bond fingers 3, it is possible to minimize cracking of the substrate 1 outside the die attach portion 2 and so minimize the risk of traces on the substrate 1 outside the die attach portion 2 being broken due to the cracking.

1. A laminated substrate for mounting a semiconductor device thereon, the laminated substrate comprising a first region adapted to have a semiconductor device attached thereto, a second region having a number of electrical contacts, and a third region located between the first region and the second region, the third region comprising a stress relief means.

2. A laminated substrate according to claim 1, wherein the stress relief means comprises an aperture in the laminated substrate.

3. A laminated substrate according to claim 2, wherein the aperture comprises a slot.

4. A laminated substrate according to claim 3, wherein the aperture comprises a number of slots.

5. A laminated substrate according to claim 3, wherein the slot comprises a linear slot.

6. A laminated substrate according to claim 3, wherein the slot comprises a non-linear slot.

7. A laminated substrate according to claim 2, wherein the aperture comprises a hole.

8. A laminated substrate according to claim 7, wherein the aperture comprises a number of holes.

9. A laminated substrate according to claim 7, wherein the hole is circular.

10. A laminated substrate according to claim 7, wherein the hole is non-circular.

11. A laminated substrate according to claim 2, wherein the aperture extends through the laminated substrate from an upperside to which the semiconductor device is to be attached to an underside of the laminated substrate.

12. A packaged semiconductor device comprising:
a semiconductor device;
a laminated substrate, the laminated substrate comprising a first region having the semiconductor device mounted thereon, a second region having a number of electrical contacts and a third region, the third region comprising a stress relief means;
electrical interconnects extending between electrical contacts on the semiconductor device and the electrical contacts on the second region; and
an electrical insulating material encapsulating the semiconductor device, the electrical interconnects, the electrical contacts in the second region and the third region.

13. A device according to claim 12, wherein the stress relief means comprises an aperture in the laminated substrate.

14. A device according to claim 13, wherein the aperture comprises a slot.

15. A device according to claim 14, wherein the aperture comprises a number of slots.

16. A device according to claim 14, wherein the slot comprises a linear slot.

17. A device according to claim 14, wherein the slot comprises a non-linear slot.

18. A device according to claim 12, wherein the aperture comprises a hole.

19. A device according to claim 18, wherein the aperture comprises a number of holes.

20. A device according to claim 18, wherein the hole comprises a circular hole.

21. A device according to claim 18, wherein the hole comprises a non-circular hole.

22. A device according to claim 13, wherein the aperture extends through the laminated substrate from an upper side to which the semiconductor device is mounted to an underside of the laminated substrate.
